(19) United States
(12) Patent Application Publication
(10) Pub. No.: US 2003/0105622 A1
(43) Pub. Date: Jun. 5, 2003

(54) Retrieval of records using phrase chunking

(75) Inventors: David M. Horowitz, London (GB); James E. Sanders, Pittsburgh, PA (US); Jared P. Kashimba, Boca Raton, FL (US); Joseph E. Simone, Lake Worth, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: NetByTel, Inc., Boca Raton, FL

(21) Appl. No.: 10/005,447

(22) Filed: Dec. 3, 2001

(51) Int. Cl. G06F 17/27

(52) U.S. Cl. 704/9

(57) ABSTRACT

Methods are provided for generating phrase chunking rules for titles of records in a database. According to one method, the title of each record in a first set of records is part-of-speech tagged, and a plurality of phrase chunking rules are created based on patterns of part-of-speech tags in the tagged titles. The phrase chunking rules are applied to the titles of records in a second set of records so as to generate indexes for the records in the second set of records. In a preferred embodiment, the phrase chunking rules are modified if coverage of the second set of records by the phrase chunking rules does not reach a predetermined threshold. Also provided are methods for retrieving records from a database and systems for generating phrase chunking rules.

### BACKGROUND OF THE INVENTION

1. Field of the Invention

The present invention relates to the field of natural language processing, and more specifically to the use of natural language processing with databases.

2. Description of Related Art

The use of speech recognition applications is on the rise. As computing power increases and speech recognition techniques improve, the capabilities of speech recognition applications are growing. In addition, as companies move towards reducing operating costs, the need for automated telephone operators has increased. Current speech recognition techniques, however, do not come without drawbacks.

A problem that is being experienced by current speech recognition techniques is the retrieval of records with long record indexes. Take, for example, a voice recognition application that relates to movies. A user connects to this application via a telephone and retrieves movie information using normal speech. A user can, for example, retrieve show times for a movie by speaking the name of the movie when prompted. Because some movies, such as “Star Wars: Episode 1—The Phantom Menace,” have long names, a user often does not remember the entire title of the movie and the system experiences difficulty in retrieving the correct movie information. This problem can also arise with a voice recognition application for product ordering when product names are long.

One conventional approach to handling this problem involves the indexing of a record with an exhaustive set of indexes. Taking the movie information voice recognition application as an example, every word of a movie title would be indexed to point towards the movie. Thus, the movie “Star Wars: Episode 1—The Phantom Menace” would produce the indexes: Star, Wars, Episode, and so on. This approach, however, produces a very large index that is over-inclusive. As a result, access times may increase and the probability of false matches increases.

Accordingly, there exists a need for a technique that effectively indexes records with long record names or titles.

### SUMMARY OF THE INVENTION

It is an object of the present invention to overcome the above-mentioned drawbacks and to provide systems, methods and computer program products for facilitating retrieval of records from a database using phrase chunking. In one preferred embodiment of the present invention, the titles of a first set of records from a database are part-of-speech tagged. Based on the patterns observed in the tagged titles, phrase chunking rules are created. Then, the phrase chunking rules are applied to the titles of a second set of records. In one embodiment, the second set of records is a complete set of database records and the first set of records is a subset of the second set of records. As a result of the application of the rules to the second set of records, a set of indexes is generated. Each of the indexes corresponds to an individual record and is stored in an index file. Next, the coverage of the phrase chunking rules is evaluated. If a coverage threshold is not reached, then the rules are modified and once again applied to the second set of records. This is repeated until the coverage threshold is reached. Subsequently, when a user submits a request for a record that corresponds to a record title, the user's request is matched to the index in the index file. This allows the record corresponding to the matched index to be retrieved from the database.

Another object of the present invention is to increase the ability of a database system to recognize a record title by the submission of a partial record title. This increases the retrieval accuracy and retrieval speed of the database system.

Yet another object of the present invention is to increase the ability of a database system to retrieve a record based on a partial record title. This increases the efficiency of the database system.

Still another object of the present invention is to increase the user-friendliness of a database system. If users are no longer required to remember the entire record title in order to retrieve the record, users are more likely to use the system. This can increase use and frequency of use of the database system.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating the overall system architecture of an embodiment of the present invention.

FIG. 2 is a flowchart depicting the operation and control flow according to one embodiment of the present invention.

FIG. 3 is a chart illustrating a record in an embodiment of the present invention.

FIG. 4 is a chart illustrating indexes corresponding to a record title in an embodiment of the present invention.

FIG. 5 is an illustration of indexes corresponding to records within a database in an embodiment of the present invention.

FIG. 6 is a flowchart depicting the operation and control flow of the indexing process according to one embodiment of the present invention.

FIG. 7 is an illustration of the retrieval of a record within a database in an embodiment of the present invention.

FIG. 8 is a flow chart depicting the operation and control flow of the record retrieval process according to one embodiment of the present invention.

FIG. 9 is a flow chart depicting the operation and control flow of the training process according to one embodiment of the present invention.

FIG. 10 is a block diagram of an exemplary computer system useful for implementing the present invention.

### DETAILED DESCRIPTION OF PREFERRED EMBODIMENTS

1. Overview of the System

The present invention is described below in terms of the exemplary embodiments. This is for convenience only and is not intended to limit the application of the present invention. In fact, after reading the following description, it will be apparent to one of ordinary skill in the relevant art(s) how to implement the present invention in alternative embodiments.

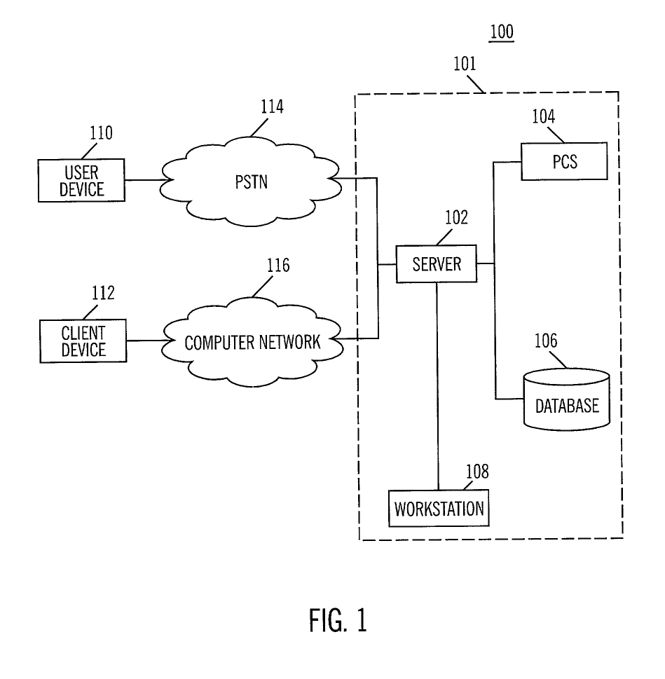

FIG. 1 is a block diagram illustrating the overall system architecture of an embodiment of the present invention. FIG. 1 is a generalized embodiment of the present invention illustrating an Application Service Provider (ASP) model of the present invention. (e.g., a method by which an entity separate from the client provides a service to the client, typically in exchange for a fee). An alternative model of the present invention (the in-house model) is also described below.

The system 100 includes a user device 110, a client device 112, a Public Service Telephone Network (PSTN) 114, a computer network 116 and an ASP 101. In one embodiment, network 116 is a packet switched wide area network (WAN) such as the global Internet. Network 116 can alternatively be a private WAN, a local area network (LAN), a telecommunications network or any combination of networks. PSTN 114 can be the circuit switched telephone network used by the public, which is also known as the Plain Old Telephone System (POTS).

Client device 112 is a network-capable device for use by an individual or a business entity. Such a device can be a PC (e.g., an IBM™ or compatible PC workstation running the Microsoft® Windows 95/98™ or Windows NT™ operating system, a Macintosh® computer running the Mac® OS operating system, or the like), a PDA, a game console or any other network-capable processing device able to communicate with ASP 101. User device 110 is a telephone-capable device such as an ordinary telephone, a mobile phone, a computer, a game console, interactive television or a personal digital assistant (PDA).

ASP 101 includes a server 102, a phrase chunking system (PCS) 104, a database system 106 and an administration workstation 108. Database 106, workstation 108 and PCS 104 are connected to server 102, which serves as the “back-bone” (i.e., provides the processing) and the “front-end” of the system. In one embodiment of the present invention, server 102 is one or more SUN Ultra workstations running the SunOS™ operating system. In another embodiment, server 102 is one or more IBM™ or compatible personal computer (PC) workstations with an Intel® Pentium® III processor running either the Windows NT™ operating system or the BSD Unix operating system. Server 102 is connected to network 116, which serves as the communications medium between ASP 101 and its clients (e.g., client device 112). Server 110 is further connected to PSTN 114, which serves as the communications medium between ASP 101 and its users (e.g., user device 110). While only one user device 110 and only one client device 112 are shown in FIG. 1 for ease of explanation, the system 100 may support any number of user devices 110 and client devices 112.

Database system 106 can be any commercially available database system implemented in hardware, software or any combination of the two. PCS 104 is a natural language processing system that may also be implemented in hardware, software or any combination of the two. Preferred embodiments of PCS 104 are described in greater detail below.

ASP 101 also includes an administrative workstation 108 connected to server 102. Administrative workstation 108 can be any processing device that may be used by personnel of ASP 101 to enter records that may be stored in database 106. Personnel may also use workstation 108 to enter into PCS 104 information that may be used to perform natural language processing. Also, administrative workstation 108 can be used to upload, update, and maintain client and user information (e.g., logins, passwords, etc.) for each of the clients and users that subscribe to ASP 101. Administrative workstation 108 may also be used to monitor and log statistics related to server 102 and system 100 in general. In addition, administrative workstation 108 may be used “off-line” by clients of system 100 in order to enter configuration data. This data is eventually stored in database 106 as described in detail below.

In some embodiments of the present invention, ASP 101 and client device 112 are integrated. This scenario represents an in-house model (as opposed to the ASP model) of the present invention. In such embodiments, the necessary functionality of ASP 101 and the functionality of client device 112 are integrated into one unit. This model represents a method by which the services performed by server 102 in the ASP model are performed by the client device itself In such embodiments, the functionality of the present invention (whether implemented in hardware, software or a combination of the two) is typically provided to the client for a fee.

It should be understood that the particular embodiment of system 100 shown in FIG. 1 is meant for illustrative purposes only and not to limit the present invention. For example, while database 106 is shown for ease of explanation, system 100 may utilize databases physically located on one or more computers which may or may not be the same as server 102, as required for a particular application. Further, in some embodiments of the present invention, these databases are mirrored for fault tolerance purposes. In another embodiment, system 100 contains separate databases for each of its clients or interested parties.

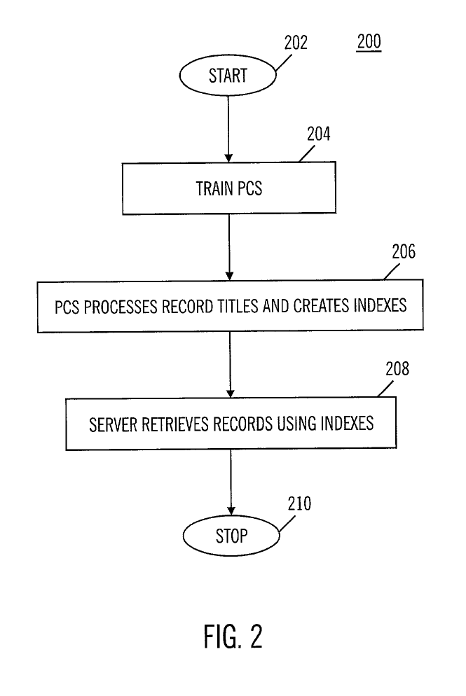

More detailed descriptions of components of system 100, as well as their functionality and inter-functionality with other components of system 100, are provided below. The operation of the system of FIG. 1 according to one embodiment of the present invention is shown in the flowchart of FIG. 2.

2. Operation of the System

Generally, system 100 represents a technique for offering record retrieval services to a user as delegated by a client. Take, for example, a movie information voice recognition application. This application can provide movie information via a telephone using voice recognition. The user can, for example, retrieve show times for a movie by speaking the name of the movie into a telephone when prompted. In this example, client device 112 is operated by a movie-related business which desires to allow movie-goers to access movie information via the telephone. Thus, client device 112 contracts with ASP 101 to provide this service. Client device 112 then provides to ASP 101 a database populated with records representing movie information. Each record represents information pertaining to a movie. The provided records can be entered into database 106 via workstation 108. Server 102, using PCS 104, then phrase chunks the title (i.e., name) of each record (with the title being a movie title in this exemplary embodiment, and more generally being a name such as a product name or a part name that uniquely identifies the data represented in the record). This phrase chunking produces an index file containing indexes for the records, with each index corresponding to a record in database 106.

Subsequently, user device 110 accesses server 102 via PSTN 114 seeking movie information. The user is prompted for a movie title. The user speaks a movie title into the telephone. Server 102, using a voice recognition application, recognizes the movie title spoken. Server 102 then searches the index file for the movie title spoken by the user. Once a match is found, server 102 then retrieves from database 106 the record that corresponds to the matched index in the index file. The information in the retrieved record is then provided to user device 110. Aggregate information can also be provided to client device 112 by server 102 via network 116. For example, server 102 can provide the number of users accessing ASP 101, the number of users accessing each record in database 106 and/or the number of records accessed by each user of ASP 101.

FIG. 2 is a flowchart depicting the operation and control flow of one embodiment of the present invention. FIG. 2 generally shows the operation of system 100. Control flow 200 begins with step 202 and flows directly to step 204.

In step 204, PCS 104 is trained to phrase chunk record titles. In step 206, PCS 104 is provided records from database 106. For example, these records can be entered into database 106 via workstation 108. PCS 104 phrase chunks the title for each record and generates indexes corresponding to each of the record titles. These indexes are then stored in an index file for later use in retrieving the records. In step 208, user device 110 accesses server 102 and provides information for retrieving a record. Server 102 then searches for a matching index in the index file based on the information supplied by user device 110.

When a match is found, server 102 retrieves the corresponding record from database 106 and provides the information within the record to user device 110. In an optional step after step 208, server 102 can send to client device 112 information regarding use of ASP 101 by users and clients. For example, server 102 can send to client device 112 aggregate information such as the number of users accessing ASP 101, the number of users accessing each record in database 106 and/or the number of records accessed by each user of ASP 101. Control flow 200 then ceases. Each step of control flow 200 is described in greater detail below.

3. Database Information

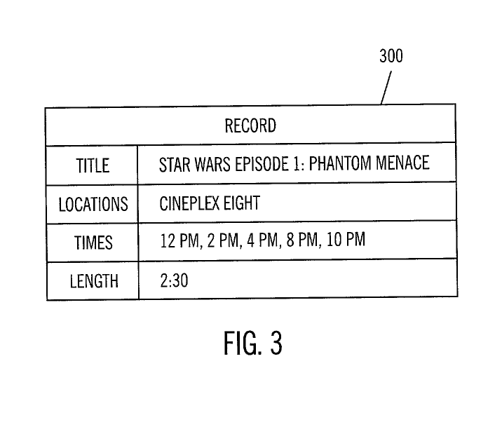

FIG. 3 is a chart illustrating a record in an embodiment of the present invention. Taking the example of a movie information voice recognition application, record 300 represents the type of information that would reside in a record that is provided to server 102 by client device 112. This record is stored in database 106 by server 102. In this example, database 106 is a relational database. However, database 106 can be of any type of database such as an object oriented or hierarchal database. Record 300 illustratively includes four data fields pertaining to a movie: the movie title, the locations at which the movie is currently showing, the show times of the movie and the length of the movie. As a relational database, record 300 can be found by a search for any of the information in any of the fields.

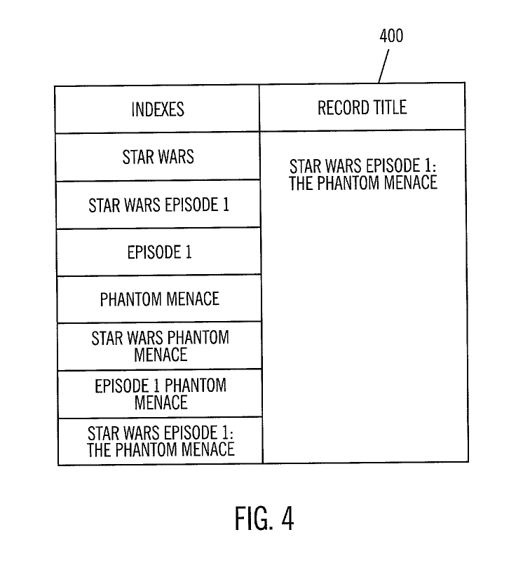

FIG. 4 is a chart illustrating indexes corresponding to a record title in an embodiment of the present invention. Taking the example of a movie information voice recognition application, chart 400 represents the indexes that are generated by PCS 104 when a record title is phrase chunked, in accordance with one embodiment of the present invention. These indexes are stored in an index file by server 102. The manner in which PCS 104 generates these indexes in described in greater detail below. Generally, PCS 104 uses natural language processing techniques to produce phrase chunks that naturally arise from the record title. Thus, when a user attempts to recall a record title, especially a record title that is long, the user need only recall a relevant portion of the full record title.

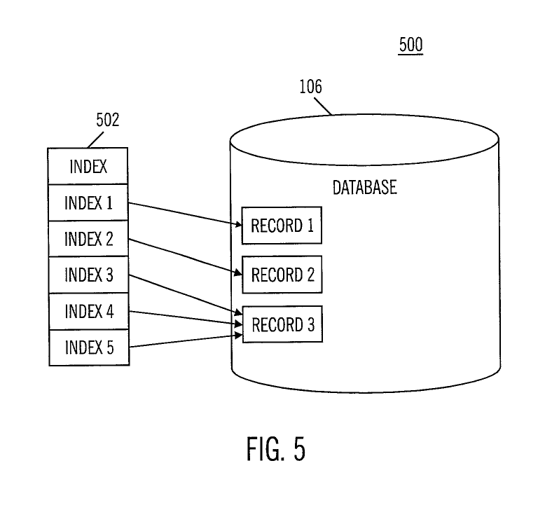

FIG. 5 is an illustration of indexes corresponding to records within database 106, in an embodiment of the present invention. FIG. 5 shows an index file 502 which is generated by PCS 104 when record titles are phrase chunked. Index file 502 consists of a list of indexes corresponding to records within database 106. Each index within index file 502 consists of a word or words and a pointer to a record in database 106. The word or words of each index is produced by PCS 104 when a record title is phrase chunked. The left column of chart 400 shows exemplary phrases or words representing indexes that each corresponding to a record in database 106. The pointer of each index can be a descriptor or a memory address corresponding to the record in database 106. The correspondence between indexes in index file 502 and records in database 106 is preferably a many-to-one relationship. In such embodiments, every index in index file 502 points to one record in database 106. Conversely, every record in database 106 has at least one index pointing to it. As shown in FIG. 5, a record in database 106 can be accessed using an index in index file 502.

In one embodiment of the present invention, identical indexes in index file 502 can point to more than one record in database 106. For example, the movie “Star Wars: Episode 1—the Phantom Menace” and the movie “Star Wars: The Empire Strikes Back” may both have an identical index such as “Star Wars.” If such an index is provided to the system by a user, a “collision” occurs in the record retrieval routine. In this case, the system can simply provide the user with all of the records associated with the common index and ask the user to manually choose the desired record from these records.

4. Phrase Chunking

Phrase chunking consists of breaking down a natural language sample into phrases or words. Typically, the generated phrases or words are such that they naturally arise from the natural language sample. Phrase chunking is performed in two major steps: part-of-speech tagging and rule application.

A. Part-of-Speech Tagging

Typically, the first step when phrase chunking a natural language sample is to part-of-speech (POS) tag the natural language sample. POS tagging can be accomplished manually by a person or by an automated POS tagger. POS tagging a natural language sample involves determining the part-of-speech of every word in the sample. The possible parts-of-speech include, but are not limited to: NOUN, VERB, ADJECTIVE, ADVERB, PRONOUN, PREPOSITION, CONJUNCTION, INTERJECTION, DETERMINER, GERUND, and INFINITIVE. Taking the example of a movie information voice recognition application, the movie title “This Child Is Mine” would be POS tagged as “This/DETERMINER Child/NOUN Is/VERB Mine/PRONOUN.” While in this exemplary embodiment the word “this” is tagged along with the other words in the title, in some embodiments articles such as “a”, “the”, “this”, and “that” are not tagged and are just dropped from the title so as to make their presence optional. This allows the desired record to be retrieved by the PCS when a user unknowingly varies the optional word (such as by saying “That Child Is Mine”)

Further, in one embodiment of the present invention, a “modified” POS tagger is used to tag the first set of records. Such a modified POS tagger sometimes applies a descriptiveness attribute as the POS tag for a word in lieu of the POS tag corresponding to the actual part-of-speech of the word. The descriptiveness attribute is either descriptive or inert. A word is deemed inert if the absence of the word does not substantially change the meaning of the phrase. In other words, inert words are the “optional” words in the title such as “from,” “the” and “his” (i.e., some prepositions, articles and pronouns). A word is deemed descriptive if the meaning of the word varies in different contexts. Examples of descriptive words are “walk,” “house” and “will” (some verbs and nouns). The modified POS tagger tags a word as descriptive or inert when it is determined that the descriptiveness attribute of a word is more useful for phrase chunking than the actual part-of-speech of the word. This condition arises in situations where the part-of-speech of a word is inconsequential for phrase chunking purposes.

For example, the movie title The Green Mile would be tagged as “The/DETERMINER Green/ADJECTIVE Mile/NOUN” by a literal POS tagger. The word “Green” in the movie title is an adjective, however, in a broader sense, the word defines more clearly the noun that it modifies—the word “Mile.” Thus, in the given movie title, the actual part-of-speech of the word “Green” is inconsequential for phrase chunking purposes. Rather, it is more important that the word has a descriptive role in the movie title. Thus, for phrase chunking purposes, the word “Green” is more usefully POS tagged as descriptive (as opposed to being POS tagged with its actual part-of-speech). In accordance with the present invention, the term “POS tags” can optionally include descriptiveness attribute tags (or any other useful attribute tags) in addition to actual part-of-speech tags.

B. Rule Application

The next step in phrase chunking is to apply a phrase chunking rule to the tagged sample. A phrase chunking rule consists of one or more POS patterns (possibly including descriptiveness attributes in the POS tags) that are sought in a record title. The POS patterns themselves define the phrase chunk or phrase chunks that result from that record title when the rule is applied. The phrase chunks generated by the application of phrase chunking rules are then used as indexes. This is described in greater detail below. The application of a phrase chunking rule can be accomplished manually by a person or by an automated program.

Taking the ongoing example of a movie information voice recognition application, the movie title “Star Wars: Episode 1—The Phantom Menace” would be POS tagged as “Star/ADJECTIVE Wars/NOUN: Episode/NOUN 1/ADJECTIVE—The/DETERMINER Phantom/ADJECTIVE Menace/NOUN.” Subsequently, consider the following phrase chunking rule: “DETERMINER ADJECTIVE NOUN.” Execution of the above rule upon the given movie title would result in the following two phrase chunks:

The Phantom Menace

Star Wars: Episode 1

This is because there was one instance (The Phantom Menace) of the given POS pattern (DETERMINER ADJECTIVE NOUN) in the given movie title. Thus, the found pattern gives one phrase chunk while the rest of the movie title gives another phrase chunk. (While this exemplary phrase chunking rule uses the remainder of the movie title to produce another phrase chunk, this is not necessarily the case for all of the phrase chunking rules.)

In one embodiment of the present invention, a phrase chunking rule can consist of more than one POS pattern. Thus, a phrase chunking rule can consist of a list of POS patterns. Each POS pattern in the list is applied to the record title to create a phrase chunk, until the entire record title is phrase chunked. Once a POS pattern is applied to a portion of the record title and a phrase chunk is generated, that portion of the record title is then no longer processed using another POS pattern from the rule. Thus, each POS pattern in the list is applied to the unprocessed part of the record title until the entire record title is phrase chunked.

Taking the ongoing example of the POS tagged movie title “Star/ADJECTIVE Wars/NOUN: Episode/NOUN 1/ADJECTIVE—The/DETERMINER Phantom/ADJECTIVE Menace/NOUN,” consider the following POS patterns comprising a phrase chunking rule:

DETERMINER ADJECTIVE NOUN

ADJECTIVE NOUN

NOUN ADJECTIVE

Execution of the above rule upon the given movie title would result in the following three phrase chunks:

Star Wars

Episode 1

(The) Phantom Menace

This is because the given movie title contained one instance of each of the three POS patterns. (While in this example the three POS patterns of the phrase chunking rule combine to capture the entire movie title, it is not necessary for the entire movie title, or any portion thereof, to be captured in the individual phrase chunks produced by one or all of the phrase chunking rules.)

In embodiments of the present invention, various techniques can be used to determine the sequence in which to apply each POS pattern of a phrase chunking rule consisting of multiple POS patterns. In one embodiment, the POS patterns are applied in the order in which they are written. In another embodiment, the POS patterns are applied randomly. In yet another embodiment, the POS patterns are applied starting from the largest POS pattern. This results in the least number of generated phrase chunks. In yet another embodiment, the POS patterns are applied starting from the smallest POS pattern. This results in the greatest number of generated phrase chunks. In further embodiments, the POS patterns can be applied in any sequence deemed to result in effective phrase chunking for a particular application.

As shown above, the phrase chunks generated by a phrase chunking rule are phrases and words that a typical person may utter when referring to the movie. It is not likely that a person would remember and speak the full movie title, but much more likely that a person would remember and use two or three consecutive words from the movie title (such as one of the above phrase chunks that naturally arise from the movie title). Thus, the movie information voice recognition application significantly benefits from being able to produce and use the above phrase chunks to identify the movie titles, as opposed to only being able to use the full movie title itself or using an exhaustive set of indexes.

In particular, this phrase chunking greatly reduces the computational complexity of the record search. A system that indexes each word of a title and can match any combination of those words to the record produces the number of combinations given by the following formula.

$$C ( n , m ) = \frac{n !}{m ! ( n - m ) !}$$

Thus, 127 index combinations must be searched for a single seven-word title such as “Star Wars: Episode 1—the Phantom Menace” as shown by the following equation.

$${\sum }_{i = 1}^{7} C ( 7 , i ) = 7 + 21 + 35 + 35 + 21 + 7 + 1 + 127$$

In contrast, if the phrase chunking system of the present invention is used to break the same seven-word title into three phrase chunks that are each used as a record index (as illustrated above), then only 7 index combinations must be searched in order to match the record with any combination of the indexes as shown by the following equation.

$${\sum }_{i = 1}^{3} C ( 3 , i ) = 3 + 3 + 1 = 7$$

Thus, the phrase chunking produces an 18 times reduction in the computational complexity of the record search.

C. Exemplary Control Flow

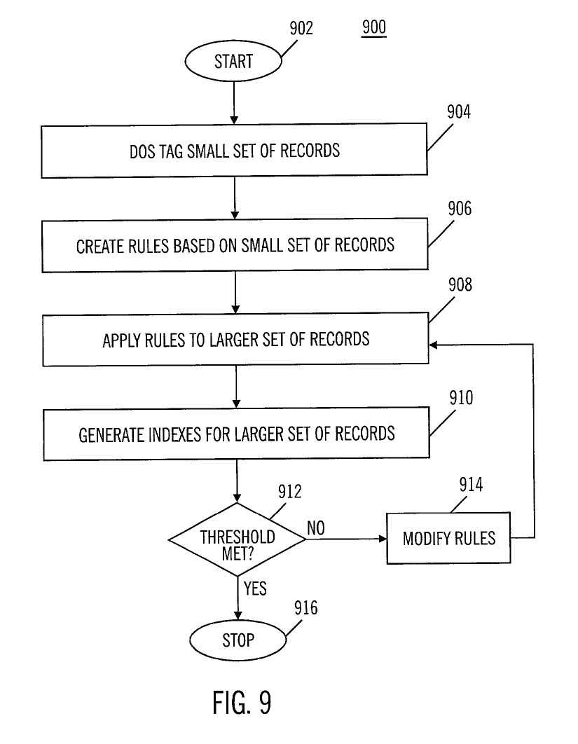

FIG. 9 is a flow chart depicting the operation and control flow of the training process of an embodiment of the present invention. FIG. 9 generally shows how PCS 104 is trained to automatically perform phrase chunking in an effective manner. FIG. 9 describes in greater detail process step 204 of FIG. 2. Control flow 900 begins with step 902 and flows directly to step 904.

In step 904, the record titles of a first set of records are POS tagged. In preferred embodiments of the present invention, the first set of records that are tagged in step 904 are a small set of records from the complete set of records. Taking the ongoing example above, a small, representative set of movie titles is used in step 904. A set of three hundred record titles, for example, can be used in this step. In one embodiment of the present invention, the record titles of the first set of records are pre-processed before they are POS tagged. Pre-processing garners additional data from the record titles for use in phrase chunking. For example, pre-processing can include punctuation analysis which may give clues as to how record titles should be phrase chunked.

In step 906, phrase chunking rules are created based on the POS tagged natural language record titles. The creation of phrase chunking rules can be accomplished manually by a person or automatically by a computer. In this step, POS patterns are observed in the tagged record titles and phrase chunking rules are created based on phrase chunks and words that naturally arise from the record titles. As described above with respect to an exemplary phrase chunking rule, the purpose of a phrase chunking rule is to generate the phrase chunks that a typical person may utter when referring to the record title. In some embodiments of the present invention, the phrase chunking rules are derived using conventional natural language techniques. In other embodiments of the present invention, the phrase chunking rules are derived using human factors analysis of human utterances when trying to recall a record title. In yet other embodiments of the present invention, the phrase chunking rules are derived using a combination of natural language techniques and human factors analysis.

In step 908, the phrase chunking rules created in step 906 are applied to a second set of records. The application of the phrase chunking rules to the second set of records involves applying each phrase chunking rule to each record title in the second set. When a phrase chunking rule is applied to a record title, it is determined whether the POS pattern of the phrase chunking rule is found in the record title. When the POS pattern is present in the record title, the record title is said to be covered by the phrase chunking rule. When the POS pattern is not present in the record title, the record title is said to not be covered by the phrase chunking rule. The coverage of a set of phrase chunking rules pertains to the percentage of records that are covered by those phrase chunking rules.

In one embodiment of the present invention, the second set of records is a complete set of records in a database. Taking the ongoing example above, the complete set of movie titles can be used in step 908. For example, a complete set of approximately 250,000 movie titles can be used.

In step 910, index file 502 is created. The application of a phrase chunking rule to a record title generates one or more indexes corresponding to the record title (see FIGS. 4 and 5). As described above, the phrase chunks created during application of a phrase chunking rule are used as indexes for the record title. Thus, in step 910, index file 502 is created, with each phrase chunk generated by the application of the phrase chunking rules to the record titles being placed in index file 502. Index file 502 can later be used to retrieve the records from the database. This is described in greater detail below.

In one embodiment of the present invention, in addition to index file 502, a coverage file is generated in step 910. In this file, each record title which is not covered by any phrase chunking rule is identified. This file can later be used by an administrator to review the coverage of the current phrase chunking rules. This file can also be used in modifying the current phrase chunking rules to achieve greater coverage.

In step 912, it is determined whether the coverage of the phrase chunking rules for the second set of records is greater than or equal to a percentage threshold. If the result of this determination is affirmative, then control flows to step 916. If the result of this determination is negative, then control flows to step 914. In preferred embodiments of the present invention, the coverage threshold of step 912 is at least about 90%, and more preferably is about 95%.

In step 914, the phrase chunking rules are modified by adding rules, deleting rules, and/or changing rules. As explained above, the coverage file can be used to modify the current phrase chunking rules in order to achieve greater coverage. In one embodiment of the present invention, one or more rules are added to the current set of phrase chunking rules in order to achieve greater coverage. Added rules can be typical phrase chunking rules (i.e., the type explained above). Added rules can also be context phrase chunking rules or statistical phrase chunking rules.

A context phrase chunking rule considers the context in which a word is used. For example, the word “to” is used differently in the movie title “To Kill a Mockingbird” than in the movie title “Back to the Future”. In the former movie title, the word is used as an infinitive, while in the later movie title the word is used as a preposition. A context phrase chunking rule considers this difference when defining the phrase chunks generated by the rule. A statistical phrase chunking rule considers the frequency with which a word is used as a particular POS. For example, a statistical phrase chunking rule may specify that the word “to” is used more frequently as an infinitive than a proposition. A statistical phrase chunking rule considers this difference when defining the phrase chunks generated by the rule. In alternative embodiments of the present invention, context phrase chunking rules and/or statistical phrase chunking rules can also be used during step 906. In step 916, control flow 900 ceases.

5. Retrieval of Records

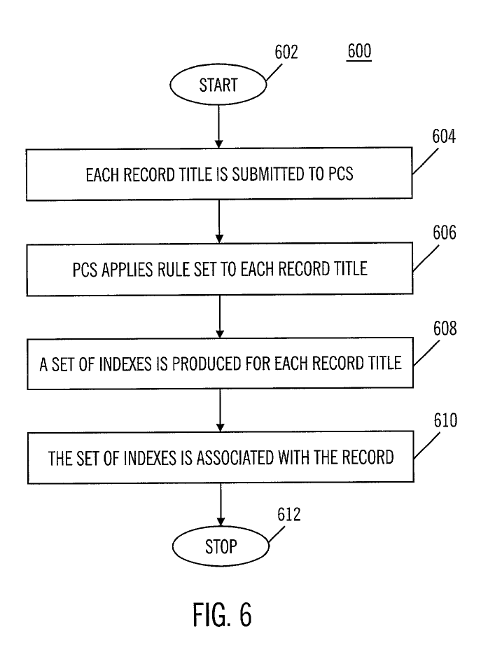

FIG. 6 is a flowchart depicting the operation and control flow 600 of the indexing process of an embodiment of the present invention. FIG. 6 generally shows how PCS 104 processes record titles subsequent to training. FIG. 6 describes in greater detail process step 206 of FIG. 2. Control flow 600 begins with step 602 and flows directly to step 604.

In step 604, each record title in a database is submitted to PCS 104. The set of record titles can be added to database 106 prior to step 604, for example via workstation 108 or via network 116. Subsequently, PCS 104 can access each added record in database 106 for phrase chunking. In step 606, PCS 104 applies each phrase chunking rule created during training to each added record title. In step 608, as a result of the application of phrase chunking rules in step 606, one or more indexes is generated for each record. These indexes are stored in index file 502. In step 610, each index is made to correspond to the record from which it was generated (by the phrase chunking rules). This can be accomplished by associating a pointer with each index. The pointer of each index can be a descriptor or a memory address corresponding to the record in database 106. In step 612, control flow 600 ceases.

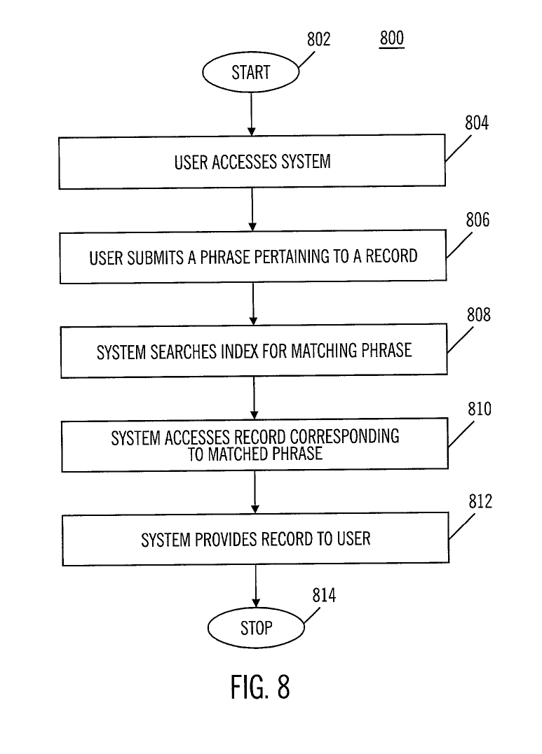

FIG. 8 is a flow chart depicting the operation and control flow 800 of the record retrieval process of an embodiment of the present invention. FIG. 8 generally shows how records are retrieved using system 100. FIG. 8 describes in greater detail process step 208 of FIG. 2. Control flow 800 begins with step 802 and flows directly to step 804.

In step 804, a user accesses ASP 101. This can be accomplished by using, for example, a telephone 110. In step 806, the user is prompted for a word or phrase corresponding to a record. Subsequently, the user submits a word or phrase to server 102. This can be accomplished by submitting natural speech over the telephone 110. In step 808, server 102 receives the submission and a matching index is sought in index file 502. Subsequently, a matching index may be found in index file 502. In step 810, server 102 accesses the record in database 106 that corresponds to the matched index in index file 502. In step 812, server 102 provides the relevant information within the retrieved record to the user via user device 110. In step 814, control flow 800 ceases.

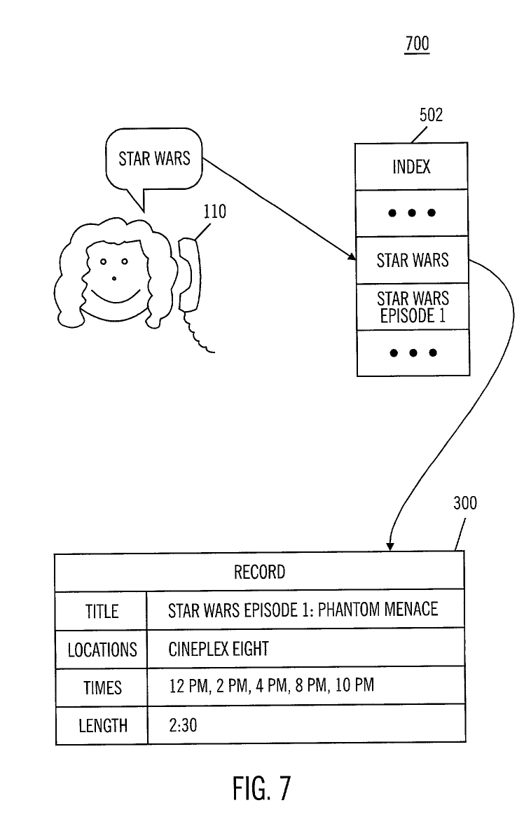

FIG. 7 is an illustration of the retrieval 700 of a record within a database in an embodiment of the present invention. FIG. 7 generally shows how records are retrieved using system 100 in a movie information voice recognition application. FIG. 7 describes in greater detail process step 208 of FIG. 2.

FIG. 7 shows a user accessing ASP 101 using a telephone 110. The user desires to access the show times for the movie “Star Wars: Episode 1—The Phantom Menace.” However, because of the long title, the user only recalls a portion of the movie title. As such, the user submits this portion of the movie title to ASP 101 using speech via the telephone 110. Server 102 recognizes this portion of the movie title and finds a matching index in index file 502. Subsequently, the pointer associated with this index is followed to the appropriate record 300 in database 106. This record is then retrieved by server 102 and the relevant information of the record is provided to the user via the telephone 110.

6. Exemplary Implementations

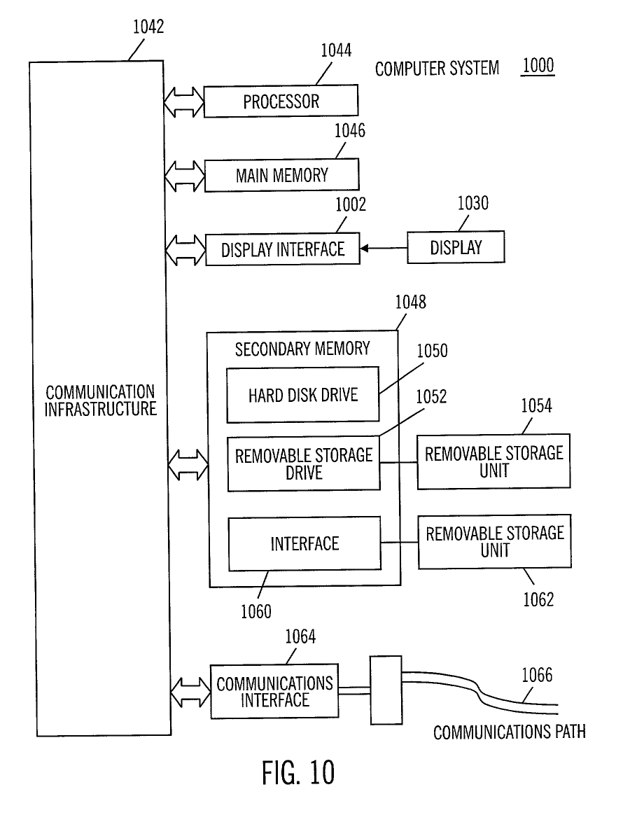

The present invention (e.g., system 100, flow 200, flow 600, flow 800, flow 900 or any part thereof) may be implemented using hardware, software or a combination thereof, and may be implemented in one or more computer systems or other processing systems. An example of such a computer system 1000 is shown in FIG. 10. The computer system 1000 represents any single or multi-processor computer. In conjunction, single-threaded and multi-threaded applications can be used. Unified or distributed memory systems can be used. Computer system 1000, or portions thereof, may be used to implement the present invention. For example, the system 100 of the present invention may comprise software running on a computer system such as computer system 1000.

In one example, system 100 of the present invention is implemented in a multi-platform (platform independent) programming language such as JAVA™, programming language/structured query language (PL/SQL), hyper-text mark-up language (HTML), practical extraction report language (PERL), Flash programming language, common gateway interface/structured query language (CGI/SQL) or the like. Java™-enabled and JavaScript™-enabled browsers are used, such as Netscape™, HotJava™, and Microsoft Internet Explorer™ browsers. Active content Web pages can be used. Such active content Web pages can include Java™ applets or ActiveX™ controls, or any other active content technology developed now or in the future. The present invention, however, is not intended to be limited to Java™, JavaScript™, or their enabled browsers, and can be implemented in any programming language and browser, developed now or in the future.

In another example, system 100 of the present invention, may be implemented using a high-level programming language (e.g., C++) and applications written for the Microsoft Windows™ or SUN™ OS environments. It will be apparent to a person of ordinary skill in the relevant art how to implement the present invention in alternative embodiments from the teachings herein.

Computer system 1000 includes one or more processors, such as processor 1044. One or more processors 1044 can execute software implementing the routines described above, such as shown in FIGS. 2, 6, 8 and 9. Each processor 1044 is connected to a communication infrastructure 1042 (e.g., a communications bus, cross-bar, or network). Various software embodiments are described in terms of this exemplary computer system. In further embodiments, the present invention is implemented using other computer systems and/or computer architectures. Computer system 1000 can include a display interface 1002 that forwards graphics, text, and other data from the communication infrastructure 1042 (or from a frame buffer) for display on the display unit 1030.

Computer system 1000 also includes a main memory 1046, preferably random access memory (RAM), and can also include a secondary memory 1048. The secondary memory 1048 can include, for example, a hard disk drive 1050 and/or a removable storage drive 1052 (such as a floppy disk drive, a magnetic tape drive, an optical disk drive, or the like). The removable storage drive 1052 reads from and/or writes to a removable storage unit 1054 in a conventional manner. Removable storage unit 1054 represents a floppy disk, magnetic tape, optical disk, or the like., which is read by and written to by removable storage drive 1052. The removable storage unit 1054 includes a computer usable storage medium having stored therein computer software and/or data.

In alternative embodiments, secondary memory 1048 may include other similar means for allowing computer programs or other instructions to be loaded into computer system 1000. Such means can include, for example, a removable storage unit 1062 and an interface 1060. Examples can include a program cartridge and cartridge interface (such as that found in video game console devices), a removable memory chip (such as an EPROM or PROM) and associated socket, and other removable storage units 1062 and interfaces 1060 which allow software and data to be transferred from the removable storage unit 1062 to computer system 1000.

Computer system 1000 can also include a communications interface 1064. Communications interface 1064 allows software and data to be transferred between computer system 1000 and external devices via communications path 1066. Examples of communications interface 1064 can include a modem, a network interface (such as an Ethernet card), a communications port, other interfaces described above, and the like. Software and data transferred via communications interface 1064 are in the form of signals which can be electronic, electromagnetic, optical or other signals capable of being received by communications interface 1064, via communications path 1066. Note that communications interface 1064 provides a means by which computer system 1000 can interface to a network such as the Internet.

The present invention can be implemented using software executing in an environment similar to that described above with respect to FIGS. 5, 6, 7, 8 and 9. The term “computer program product” includes a removable storage unit 1054, a hard disk installed in hard disk drive 1050, or a carrier wave carrying software over a communication path 1066 (wireless link or cable) to communication interface 1064. A “machine-readable medium” can include magnetic media, optical media, semiconductor memory or other recordable media, or media that transmits a carrier wave or other signal. These computer program products are means for providing software to computer system 1000.

Computer programs (also called computer control logic) are preferably stored in main memory 1046 and/or secondary memory 1048. Computer programs can also be received via communications interface 1064. Such computer programs, when executed, enable the computer system 1000 to perform the features of the present invention as discussed herein. In particular, the computer programs, when executed, enable the processor 1044 to perform features of the present invention. Accordingly, such computer programs represent controllers of the computer system 1000.

The present invention can be implemented as control logic in software, firmware, hardware or any combination thereof. In an embodiment in which the present invention is implemented using software, the software may be stored on a computer program product and loaded into computer system 1000 using removable storage drive 1052, hard disk drive 1050, or interface 1060. Alternatively, the computer program product may be downloaded to computer system 1000 over communications path 1066. The control logic (e.g., software), when executed by one or more processors 1044, causes the processor(s) 1044 to perform functions of the present invention as described herein.

In another embodiment, the present invention is implemented primarily in firmware and/or hardware using, for example, hardware components such as application specific integrated circuits (ASICs). A hardware state machine is implemented so as to perform the functions described herein.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for generating phrase chunking rules for titles of records in a database, said method comprising the steps of:
part-of-speech tagging the title of each record in a first set of records;
creating a plurality of phrase chunking rules based on patterns of part-of-speech tags in the tagged titles; and
applying the phrase chunking rules to the titles of records in a second set of records so as to generate indexes for the records in the second set of records.

2. The method of claim 1, further comprising the step of modifying the phrase chunking rules if coverage of the second set of records by the phrase chunking rules does not reach a predetermined threshold.

3. The method of claim 2, further comprising the step of repeating the applying step and the modifying step until the coverage of the second set of records by the phrase chunking rules reaches the predetermined threshold.

4. The method of claim 2, further comprising the step of:
after the applying step, generating a third set of records consisting of records in the second set of records that were not covered by the phrase chunking rules.

5. The method of claim 1, wherein in the part-of-speech tagging step, words of the title of each record in the first set of records are assigned part-of-speech tags, and the part-of-speech tags include descriptiveness attribute tags.

6. The method of claim 1, wherein the first set of records is a subset of the second set of records.

7. The method of claim 1,
wherein the second set of records includes all of the records in the database, and
the first set of records includes at least one record that is not in the database.

8. The method of claim 1, wherein the creating step includes the sub-step of creating at least one of the phrase chunking rules based on human factors analysis.

9. The method of claim 1, wherein the phrase chunking rules include at least one of context sensitive phrase chunking rules and statistical phrase chunking rules.

10. The method of claim 1, wherein each title is one of a product name, a part name, a movie title, a show title, and an album title.

11. A method for retrieving records from a database, said method comprising the steps of:
applying a plurality of phrase chunking rules to titles of the records in the database so as to generate indexes for the records in the database;
receiving a request for one of the records in the database, the request including at least part of the title of one of the records in the database;
comparing the at least part of the title that is received with the indexes that were generated; and
if the at least part of the title that is received matches one of the indexes, retrieving the record corresponding to the one index.

12. The method of claim 11, further comprising the steps of:
part-of-speech tagging the title of each record in a first set of records; and
creating the plurality of phrase chunking rules based on patterns of part-of-speech tags in the tagged titles.

13. The method of claim 12, further comprising the steps of:
modifying the plurality of phrase chunking rules if coverage of the records in the database by the phrase chunking rules does not reach a predetermined threshold; and
repeating the applying step and the modifying step until the coverage of the records in the database by the phrase chunking rules reaches the predetermined threshold.

14. The method of claim 12, wherein the first set of records includes at least one record that is not in the database.

15. A machine-readable medium encoded with a program for generating phrase chunking rules for titles of records in a database, said program containing instructions for performing the steps of:
part-of-speech tagging the title of each record in a first set of records;
creating a plurality of phrase chunking rules based on patterns of part-of-speech tags in the tagged titles; and
applying the phrase chunking rules to the titles of records in a second set of records so as to generate indexes for the records in the second set of records.

16. The machine-readable medium of claim 15, wherein said program further contains instructions for performing the step of modifying the phrase chunking rules if coverage of the second set of records by the phrase chunking rules does not reach a predetermined threshold.

17. The machine-readable medium of claim 16, wherein said program further contains instructions for performing the step of repeating the app lying step and the modifying step until the coverage of the second set of records by the phrase chunking rules reaches the predetermined threshold.

18. The machine-readable medium of claim 16, wherein said program further contains instructions for performing the step of:
after the applying step, generating a third set of records consisting of records in the second set of records that were not covered by the phrase chunking rules.

19. The machine-readable medium of claim 15, wherein in the part-of-speech tagging step, words of the title of each record in the first set of records are assigned part-of-speech tags, and the part-of-speech tags include descriptiveness attribute tags.

20. The machine-readable medium of claim 15, wherein the creating step includes the sub-step of creating at least one of the phrase chunking rules based on human factors analysis.

21. The machine-readable medium of claim 15, wherein the phrase chunking rules include at least one of context sensitive phrase chunking rules and statistical phrase chunking rules.

22. A machine-readable medium encoded with a program for retrieving records from a database, said program containing instructions for performing the steps of:
applying a plurality of phrase chunking rules to titles of the records in the database so as to generate indexes for the records in the database;
receiving a request for one of the records in the database, the request including at least part of the title of one of the records in the database;
comparing the at least part of the title that is received with the indexes that were generated; and
if the at least part of the title that is received matches one of the indexes, retrieving the record corresponding to the one index.

23. The machine-readable medium of claim 22, wherein said program further contains instructions for performing the steps of:
part-of-speech tagging the title of each record in a first set of records; and
creating the plurality of phrase chunking rules based on patterns of part-of-speech tags in the tagged titles.

24. The machine-readable medium of claim 23, wherein said program further contains instructions for performing the steps of:
modifying the plurality of phrase chunking rules if coverage of the records in the database by the phrase chunking rules does not reach a predetermined threshold; and
repeating the applying step and the modifying step until the coverage of the records in the database by the phrase chunking rules reaches the predetermined threshold.

25. The machine-readable medium of claim 23, wherein the first set of records includes at least one record that is not in the database.

26. A system for generating phrase chunking rules for titles of records in a database, said system comprising:
a part-of-speech tagger for part-of-speech tagging the title of each record in a first set of records;
first means for creating a plurality of phrase chunking rules based on patterns of part-of-speech tags in the tagged titles; and
an indexer for applying the phrase chunking rules to the titles of records in a second set of records so as to generate indexes for the records in the second set of records.

27. The system of claim 26, wherein the first means modifies the phrase chunking rules if coverage of the second set of records by the phrase chunking rules does not reach a predetermined threshold.

28. The system of claim 26, wherein the part-of-speech tagger assigns part-of-speech tags to words of the title of each record in the first set of records, and the part-of-speech tags include descriptiveness attribute tags.

29. The system of claim 26, wherein the first set of records is a subset of the second set of records.

30. The system of claim 26, wherein the phrase chunking rules include at least one of context sensitive phrase chunking rules and statistical phrase chunking rules.

31. The system of claim 26, further comprising:
an interface for receiving a request for one of the records in the second set of records, the request including at least part of the title of one of the records in the second set of records;
second means for comparing the at least part of the title that is received with the indexes that were generated; and
third means for retrieving the record corresponding to the one of the indexes if the at least part of the title that is received matches the one index.

32. The system of claim 31, wherein the first means modifies the phrase chunking rules if coverage of the second set of records by the phrase chunking rules does not reach a predetermined threshold.
